(19) United States
(12) Patent Application Publication
(10) Pub. No.: US 2026/0002508 A1
(43) Pub. Date: Jan. 1, 2026

(54) WAVE POWER HARVESTING ASSEMBLY

(71) Applicant: TidalX AI Inc., Mountain View, CA (US)

(72) Inventors: Thomas Robert Swanson, Sunnyvale, CA (US); Harrison Pham, Sunnyvale, CA (US)

(21) Appl. No.: 19/246,887

(22) Filed: Jun. 24, 2025

Related U.S. Application Data
(60) Provisional application No. 63/664,246, filed on Jun. 26, 2024.

(51) Int. Cl. F03B 13/18; F03B 13/10

(52) U.S. Cl. CPC F03B 13/18; F03B 13/10

(57) ABSTRACT

The present disclosure relates to an aquatic power harvesting system. The system comprises an anchor line configured for coupling to a floatable structure at a water surface and anchoring the floatable structure to a floor. A power harvesting generator is coupled to the anchor line and is configured for generating power for the floatable structure by converting a movement in the anchor line to an output while the generator is submerged under the water surface. The generator comprises a housing having a first end coupled to the anchor line, a core disposed inside the housing and movable relative to the housing in response to a tension or an absence of tension in the anchor line, and a controller coupled to the housing and configured for converting an input to the output.

### CROSS-REFERENCE TO RELATED APPLICATIONS

This application claims priority of U.S. Provisional Application Ser. No. 63/664,246 filed Jun. 26, 2024. The contents of the prior application is incorporated herein by reference in its entirety.

### TECHNICAL FIELD

The present disclosure relates to a power harvesting assembly, and in particular, to a power harvesting assembly and system for converting wave energy into power.

### BACKGROUND

Aquaculture pens are installed in remote, off-shore locations, and are often out of reach of reliable power from a traditional power grid. These sites typically rely on diesel generators or unreliable power connections back to the shore. However, even when power is available to a site, the power is not always connected to individual pens.

### SUMMARY

The present disclosure relates to an aquatic power harvesting system for generating power on site at remote, off-shore locations. The power harvesting system is configured to convert natural, aquatic motion, such as waves, swells, tide, currents, etc., into power that can be used for various applications on site. In the examples described herein, the power harvesting system is used with a fixed aquaculture net installation, or fish pen and infrastructure. However, the power harvesting generator may be used in other aquatic applications.

In a first aspect, an aquatic power harvesting system may include an anchor line configured for coupling to a floatable structure at a water surface and anchoring the floatable structure to a floor. A power harvesting generator may be coupled to the anchor line, and configured for generating power for the floatable structure by converting a movement in the anchor line to an output power while the generator is submerged under the water surface. The generator may include a housing having a first end coupled to the anchor line, a core disposed inside the housing and movable relative to the housing in response to a tension or an absence of tension in the anchor line, and a controller coupled to the housing and configured for converting an input power to the output power.

In a second aspect, a submergible power harvesting generator may include a housing having a closed end, an open end, and a longitudinal axis extending between the closed end and the open end. A core may be disposed through the open end of the housing and movable relative to the longitudinal axis of the housing. A coil may be disposed in the housing and positioned around an exterior surface of the core. A magnet may be coupled to the core and may be configured to induce an input in the coil in response to movement of the core.

In a third aspect, a method of generating power from waves may include submerging a power harvesting generator under a water surface. The power harvesting generator may be disposed between a fish pen at the water surface and a floor. The power harvesting generator may include a housing and a core movably disposed relative to the housing. The method may include moving the core relative to the housing in response to a wave. The core may include a magnet and may be movably disposed within a coil disposed in the housing. The method may include generating a current in the coil and transmitting the current to a controller disposed in the housing.

### Definitions

As used herein, the term “about” means +/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the apparatus.

Other features and advantages of the present disclosure will be apparent from the following detailed description, figures, and claims.

### BRIEF DESCRIPTION OF THE DRAWINGS

FIG. 1 is a diagram of an aquatic power harvesting system, constructed in accordance with the teachings of the present disclosure;

FIG. 2 is an example of a power harvesting generator of the power harvesting system of FIG. 1, showing the generator in a first position;

FIG. 3 is the generator of FIG. 2 in a second position; and

FIG. 4 is an example of a circuit diagram of a power converter of the generator of FIG. 2.

### DETAILED DESCRIPTION

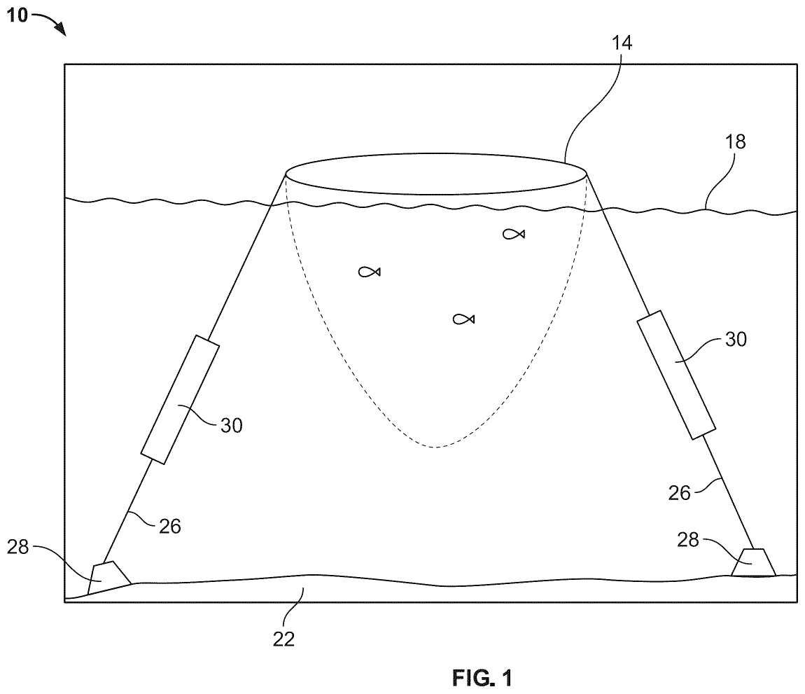

The present disclosure relates to an aquatic power harvesting system for generating power on site at remote, off-shore locations. The power harvesting system is configured to convert natural, aquatic motion, such as waves, swells, tide, currents, etc., into power that can be used for various applications on site. In one non-limiting example shown in FIG. 1, a power harvesting system 10 is integrated with a fish pen 14 positioned at a water surface 18 and is anchored to a sea floor 22 by one or more anchor lines 26 and anchors 28. The fish pen 14 may be one of a dozen separate large fish pens of a farm, such as, for example, a salmon farm, where each fish pen 14 measures approximately 50 meters in diameter. Fish farms may have a variety of different power needs. For example, some farms provide lighting to affect the quality and growth of the fish, utilize cameras for monitoring the fish, and feed the fish using automated feeding systems. According to the present disclosure, fish farms that utilize the example power harvesting system 10 can generate power to meet the farm's power needs. The system 10 may provide a sustainable, clean supplementary power source or replace current power sources, such as diesel generators, to remote fishing farms.

The system 10 of FIG. 1 includes one or more power harvesting generators 30 submerged underwater and disposed in-line with the anchor lines 26 of the fish pen 14. The power harvesting generator 30 is disposed between the sea floor 22 and the floating pen infrastructure 14, and captures wave energy transferred to the anchor lines 26. For example, the anchor lines 26 are subject to wave dynamics that apply tension or release tension in the anchor lines 26. In response to the tension in the anchor lines, the generators 30 are configured to generate power by converting a movement in the anchor line 26 (e.g., presence of tension or absence of tension) to an output power, which is then transmitted above the water surface 18 to power various energy needs at the fish pen 14. Specifically, the generators 30 reduce energy loss during power transmission to the surface by converting a high-current, low voltage input power to a lower-current, higher voltage output power. In other examples, the power harvesting generator 30 may be coupled to a different floatable structure and/or used in other aquatic applications and environments. In another example, the system 10 may be configured to provide multiple generators 30 coupled to one anchor line 26, where the multiple generators 30 are disposed in parallel and/or in series with the other generator(s) 30.

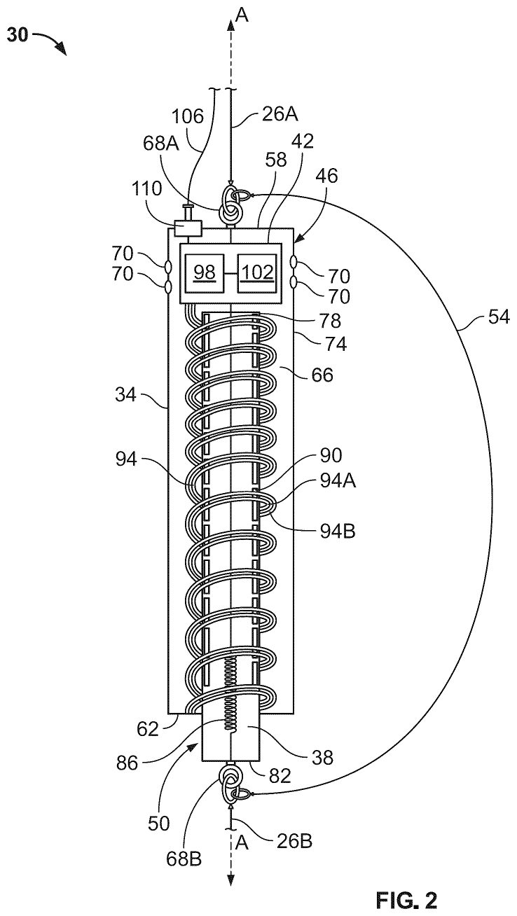

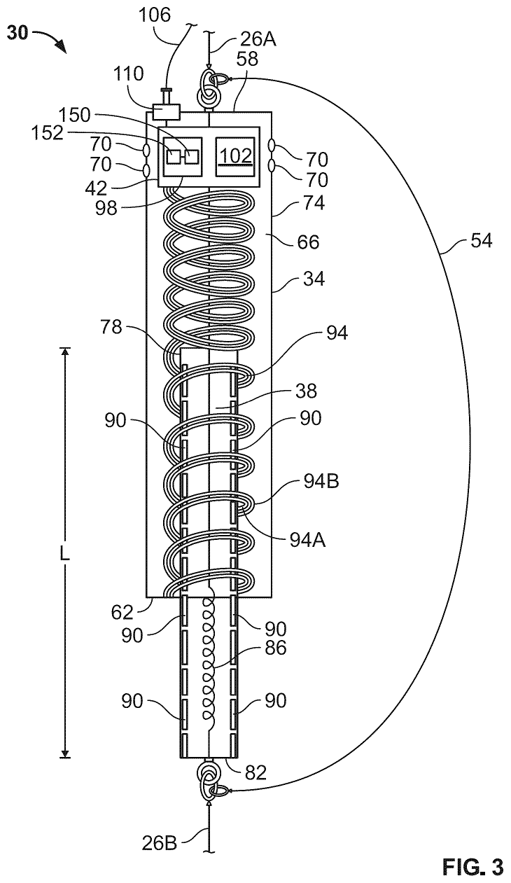

In FIGS. 2 and 3, the power harvesting generator 30 includes a housing 34, a core 38, a control system 42, a first end 46, and a second end 50. The core 38 is partially disposed within the housing 34, and moves relative to the housing 34 in response to movement of the generator 30. The housing 34 and core 38 are made of a corrosion-resistant material. For example, the housing 34 and/or core 38 may be an aluminum, plastic, rubber, or a combination thereof. At the first end 46 of the generator 30, a first portion 26A of the anchor line 26 connects the generator 30 to the fish pen 14, and at the second end 50 of the generator 30, a second portion 26B of the anchor line 26 connects the generator 30 to the anchor 28 at the sea floor 22. Specifically, the first portion 26A is coupled to the housing 34 and the second portion 26B is coupled to the core 38 of the generator 30. A tether 54 couples the first portion 26A to the second portion 26B of the anchor line 26 to secure the anchor line 26 as a safety measure. So configured, the housing 34 and the core 38 move relative to each other in response to movements in the first and second portions 26A, 26B of the anchor line 26. As will be described further below, the generator 30 generates an output power as the housing 34 and core 38 move in response to wave forces on the anchor line 26.

The housing 34 is cylindrical and has a first end 58, a second end 62 opposite the first end 58, and a cavity 66 extending between the first and second ends 58, 62. The first end 58 is closed and the second end 62 is open. A plurality of vents 70 are disposed through a wall 74 of the housing 34 at the first end 58, and fluidly couple the cavity 66 with the surrounding environment. The vents 70 permit water that is disposed in the cavity 66 of the housing 34 to exit through the first end 58, thereby releasing pressure within the cavity 66. In the illustrated example, the housing 34 has two rows of vents 70, and the vents 70 in each row are equally spaced about a circumference of the housing 34. However, in other examples, the generator 30 may have more or fewer rows of vents 70 at the first end 58 or in other locations.

The core 38 is cylindrical and is axially aligned with a longitudinal axis A of the housing 34. The core 38 has a first end 78, a second end 82 opposite the first end 78, and a spring 86 that couples the second end 82 of the core to the first end 58 of the housing 34. The core 38 is disposed inside the housing 34, and is movable relative to the housing 34 in response to a tension or an absence of tension in the anchor line 26. The second end 82 of the core 38 is coupled to the second portion 26B of the anchor line 26. A first fastener 68A attached to the wall 74 of the housing 34 couples the first portion 26A of the anchor line 26 to the first end 58 of the housing 34; and a second fastener 68B attached to the second end 82 of the core 38 couples the core 38 to the second portion 26B of the anchor line 26.

When the generator 30 is in a neutral position shown in FIG. 2, the first end 78 of the core 38 is disposed inside the cavity 66 of the housing 34 and proximally located to the control system 42 and first end 58 of the housing 34. The second end 82 is externally disposed relative to the housing 34. In response to a wave, the second portion 26B of the anchor line 26 pulls the core 38 away from the housing 34 and energizes the spring 86. The spring 86 is configured to return the core 38 to the neutral position when there is no tension in the anchor line 26. In the illustrated example, the spring 86 is a homing spring and is in a non-energized state when the core 38 is in the neutral position, and is in an energized state as the core 38 moves axially away from the housing 34, as shown in FIG. 3.

The generator 30 converts a movement in the anchor line 26 to an output power by capturing energy generated as the core 38 moves relative to the housing 34. Specifically, as the core 38 moves axially relative to the longitudinal axis A of the housing 34, a plurality of magnets 90 coupled to the core 38 moves relative to a coil 94, and is disposed in the cavity 66 of the housing 34. The plurality of magnets 90 are neodymium magnets and are disposed along a length L of the core 38. The coil 94 is disposed between the housing and the core 38, and defines an interior spaced sized to receive the core 38 carrying the magnets 90. As the core 38 moves through the interior space of the coil 94, an input power is induced in the coil 94, which is transmitted to the control system 42. The input power is a high-current, low-voltage power. In the illustrated example, the coil 94 includes a primary coil 94A and a secondary or backup coil 94B coaxially aligned with the inner coil. However, in other examples, the generator 30 may have more or fewer than two co-axial coils.

The control system 42 of the generator 30 is configured to receive an input from the coil 94 and boost that input from a high-current, low-voltage power into lower-current, higher-voltage power that is suitable for power transmission. The control system 42 includes a controller 98, which may be a boost converter, and a battery 102 coupled to the controller 98. The battery 102 may be a rechargeable battery that stores generated power. A transmission line 106 is electrically coupled to the control system 42 at a connection port 110 disposed in the wall 74 at the first end 58 of the housing 34. So configured, the transmission line 106 receives the output power from the controller 98 and transmits the output power to the fish pen. In some examples, the transmission line 106 is bidirectional and configured to transmit power from above the water surface (i.e., from the fish pen 14) to the generator 30. For example, power can be transmitted from the shore to the coil 94 under extreme weather conditions to actuate the system in such a way as to cancel out the motion of very large waves.

The controller 98 is a dynamic, power converter and may be configured to optimize energy conversion for strong and light waves by presenting an adjustable load impedance that matches the output of the coil and maximizes the amount of usable power. For example, when a strong wave hits the anchor line 26, the housing 34 and core 38 of the generator 30 are pulled apart by the strong force of the wave. Without a dynamic controller, the core 38 and the housing 34 would be pulled away quickly, and remain in a fully extended position for the entire length of the wave until the homing spring 86 pulls the core 38 back to its neutral position. Any power generation would therefore be limited to a fraction of the length of the wave, and may generate too much power over a short amount of time. However, with a dynamic controller 98, the control system 42 can capture energy from the entire length of the wave by resisting the sudden movement of the housing 34 and core 38 to move in opposite directions. The controller 98 may effectively slow down the piston movement of the generator 30, increasing the time and length of the wave that the generator 30 can capture energy. In this way, the controller 98 optimizes wave energy for large waves.

The controller 98 is also configured to adjust an impedance in response to the input power. In some examples, the controller 98 may be programmed to adjust the impedance from an input of a wave so that the generator 30 can generate a steady source of power. For example, in response to a large wave, as described above, the controller 98 may adjust the impedance in response to the input power to slow down the piston movement of the generator 30. In this way, the controller 98 may be programmed to learn ocean wave dynamics to optimize power generation.

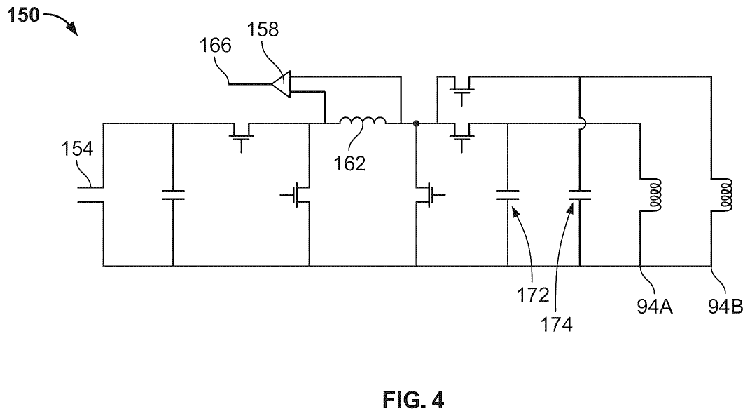

FIG. 4 illustrates an example circuit diagram 150 of the power converter or controller 98 of the generator 30. The illustrated circuit converts voltage bi-directionally and supports multiple piston windings or coils. The primary piston coil 94A and a back-up coil 94B are connected in parallel and are configured to drive current, induced from the movement of the core 38 of the generator 30, to a high voltage DC power output 154. The output 154 of the controller 98 is located at the first end 58 of the housing 34, and is coupled to the power transmission line 106 to send the output power above or at the water surface, where the voltage is further converted to whatever voltage is required for the storage or load devices. An amplifier 158 measures voltage across an inductor 162, and transmits an output power signal 166 (i.e., a measurement of current through the power converter) to a processor 152 of the controller 98. The amplifier 158 may be a high-bandwidth, high-gain opamp. The circuit diagram 150 also includes two snubber caps 172, 174 disposed in parallel. The controller 98 may also include one or more processors and a memory for storing executable instructions that enables automatic operation of adjusting impedance according to the size of the wave, and/or other features or programs of the power harvesting system 10. For example, a control algorithm of the processor 152 receives the measurement of the current and adjusts an impedance accordingly. Referring to the example above, in response to a very large wave, the high current measurement read by the controller 98 would cause an increase of impedance to lower the voltage output 154.

The power harvesting system described herein advantageously captures power at a remote, off-shore location using natural ocean dynamics, thereby providing a sustainable power source to fishing pens or other off-shore facilities. The power captured by the disclosed systems can provide power to enable pen automation and provide power to other on-site power needs. During large storms, rather than lose power (due to damage of traditional power structures), the pens equipped with the disclosed systems can actually take advantage of the storm conditions to generate and store more power. The power converter of the generator described herein converts the high-current, low-voltage power from the coil into lower-current, higher-voltage power to reduce losses during power transmission to the surface. Further, the power converter presents an adjustable load impedance that matches the output of the coil and maximizes the amount of power collected.

The system is configured for bi-directional use, and therefore can be reconfigured to drive the piston to dampen excessive net forces during extreme weather. This feature can provide additional safety measures for workers on-site by providing stability to the platform.

Further, the disclosed system has a tension-tracking assembly that may be tuned to take up slack during a change in tide conditions. This feature ensures that the net tether lines do not become too slack and allow the pen to drift.

While this specification contains many specific implementation details, these should not be construed as limitations on the scope of any disclosure or of what may be claimed, but rather as descriptions of features that may be specific to particular examples of particular disclosures. Certain features that are described in this specification in the context of separate examples can also be implemented in combination in a single example. Conversely, various features that are described in the context of a single example can also be implemented in multiple examples separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the examples described herein should not be understood as requiring such separation in all examples, and it should be understood that the described program components and systems can generally be integrated together in a single product or packaged into multiple products.

Particular examples of the subject matter have been described. Other examples are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. An aquatic power harvesting system, the system comprising:
an anchor line configured for coupling to a floatable structure at a water surface and anchoring the floatable structure to a floor;
a power harvesting generator coupled to the anchor line, and configured for generating power for the floatable structure by converting a movement in the anchor line to an output power while the generator is submerged under the water surface, the generator comprising:
a housing having a first end coupled to the anchor line;
a core disposed inside the housing and movable relative to the housing in response to a tension or an absence of tension in the anchor line; and
a controller coupled to the housing and configured for converting an input power to the output power.

2. The aquatic power harvesting system of claim 1, wherein the power harvesting generator is disposed in-line with the anchor line.

3. The aquatic power harvesting system of claim 1, wherein the first end of the housing is closed and a second end of the housing, opposite the first end, is open.

4. The aquatic power harvesting system of claim 3, wherein the core is disposed through the open end of the housing.

5. The aquatic power harvesting system of claim 3, wherein the closed end of the housing comprises one or more vents.

6. The aquatic power harvesting system of claim 1, wherein a first end of the core is disposed inside the housing and a second end is externally disposed relative to the housing.

7. The aquatic power harvesting system of claim 6, wherein the second end of the core is coupled to the anchor line.

8. The aquatic power harvesting system of claim 6, comprising a spring coupling the first end of the housing with the second end of the core, the spring being configured to return the core to a neutral position relative to the housing.

9. (canceled)

10. The aquatic power harvesting system of claim 1, wherein the generator comprises a plurality of magnets coupled to the core and a coil disposed between the housing and the core.

11-12. (canceled)

13. The aquatic power harvesting system of claim 1, wherein the anchor line comprises a first portion configured for connecting the generator to the floatable structure and a second portion connecting the generator to the anchor.

14-15. (canceled)

16. The aquatic power harvesting system of claim 1, comprising a transmission line comprising a first end configured for coupling to the floatable structure above the water surface and a second end coupled to the controller of the generator, the transmission line being configured for receiving the output power.

17-19. (canceled)

20. A submergible power harvesting generator, the generator comprising:
a housing having a closed end, an open end, and a longitudinal axis extending between the closed end and the open end;
a core disposed through the open end of the housing and movable relative to the longitudinal axis of the housing;
a coil disposed in the housing and positioned around an exterior surface of the core; and
a magnet coupled to the core, the magnet being configured to induce an input in the coil in response to movement of the core.

21. The generator of claim 20, comprising a controller coupled to the housing and configured for receiving the input from the coil and converting the input to an output, wherein the input is a high-current, low voltage power and the output is a lower-current, higher-voltage power.

22. The generator of claim 21, wherein the controller comprises:
one or more processors;
a memory communicatively coupled to the one or more processors and storing executable instructions that, when executed by the one or more processors, causes the one or more processors to:
receive an output signal of a current generated by the coil;
analyze the output signal to identify a status or condition associated with a wave; and
change an impedance in response to the status or condition.

23-30. (canceled)

31. The generator of claim 20, comprising a spring coupling the closed end of the housing with a second end of the core, the spring configured to return the core to a neutral position relative to the housing.

32. (canceled)

33. A method of generating power from waves, the method comprising:
submerging a power harvesting generator under a water surface, the power harvesting generator disposed between a fish pen at the water surface and a floor, the power harvesting generator comprising a housing and a core movably disposed relative to the housing;
moving the core relative to the housing in response to a wave, the core comprising a magnet and the core being movably disposed within a coil disposed in the housing; and
generating a current in the coil and transmitting the current to a controller disposed in the housing.

34. The method of claim 33, comprising storing a voltage in a battery of the controller.

35. (canceled)

36. The method of claim 33, comprising returning the core to a neutral position relative to the housing.

37. The method of claim 33, wherein moving the core comprises axially moving the core relative to a longitudinal axis of the housing.

38. The method of claim 33, wherein moving the core comprises pulling the core away from the housing through an anchor line, the core coupled to the anchor line that anchors the fish pen to the flooring.
